(19) United States
(12) Patent Application Publication
(10) Pub. No.: US 2016/0325751 A1
(43) Pub. Date: Nov. 10, 2016

(54) VEHICLE CONTROL DEVICE AND TRANSMISSION APPARATUS CONTROL DEVICE

(71) Applicant: AISIN AW CO., LTD., Anjo-shi (JP)

(72) Inventors: Masakazu KAIFUKU, Anjo-shi (JP); Shiko YOSHIMURA, Nakatsugawa (JP)

(73) Assignee: AISIN AW CO., LTD., Anjo-shi (JP)

(21) Appl. No.: 15/108,691

(22) PCT Filed: Feb. 26, 2015
(86) PCT No.: PCT/JP2015/055634

§ 371 Date: Jun. 28, 2016

(30) Foreign Application Priority Data
Feb. 28, 2014 (JP) 2014-039108

(51) Int. Cl. B60W 30/19; B60W 10/06; B60K 6/52; F16H 3/72; B60W 20/40; B60K 6/54; B60W 10/08; B60W 10/115

(52) U.S. Cl. CPC B60W 30/19; B60W 10/08; B60W 10/06; B60W 10/115; F16H 3/725; B60W 20/40; B60K 6/54; B60K 6/52; B60W 2510/1005; B60W 2540/10; B60W 2710/0666; F16H 2200/0052; F16H 2200/2007; F16H 2200/2046; F16H 2200/2066; F16H 2200/2082; Y10S 903/916; Y10S 903/917; B60Y 2300/80; Y10S 903/93; B60Y 2200/92

(57) ABSTRACT

A vehicle control device for controlling a vehicle driving device including an internal combustion engine as a driving force source for a wheel and a transmission apparatus, wherein the transmission apparatus includes a transmission shift input member drivably coupled to the internal combustion engine, a transmission shift output member drivably coupled to the wheel, and a transmission mechanism having a plurality of engagement devices and selectively forming a plurality of transmission shift stages having different transmission shift ratios depending on engagement states of the plurality of engagement devices.

### BACKGROUND

The present disclosure relates to a vehicle control device controlling a vehicle driving device having an internal combustion engine as a driving force source for wheels and a transmission apparatus and to a transmission apparatus control device for controlling the transmission apparatus which is drivably coupled to the internal combustion engine as the driving force source for the wheels and configures the vehicle driving device in combination with the internal combustion engine.

In a vehicle including an internal combustion engine and transmission apparatus, the driver may perform inertial travel of the vehicle by releasing the accelerator before stopping or during traveling on a gentle downhill. When engagement devices of the transmission apparatus are engaged in inertial travel, a resistance force against the travel is generated. For example, continuous travel on a gentle downhill leads to an increase in fuel consumption. Accordingly, in such a case, control may be made to enter a neutral state (state in which power transmission between the internal combustion engine and wheels is released) in which the transmission apparatus does not form transmission shift stages. When the driver accelerates the vehicle by operating the accelerator, an appropriate transmission shift stage needs to be formed in the transmission apparatus in the neutral state according to the travel speed and torque of the vehicle.

When engagement devices are engaged to form a transmission shift stage in the transmission apparatus, the rotation speed of the rotary member of the engagement devices close to the internal combustion engine desirably matches the rotation speed of the rotary member close to the wheels within a predetermined range. In addition, to reduce an engagement shock occurring at this time, torque reduction for instantaneously reducing the output torque of the internal combustion engine at the time of engagement of engagement devices may be performed. When the travel speed (the rotation speed of the axle) of the vehicle is constant, it is relatively easy to make control so that torque reduction is made in the state in which the rotation speed of the input shaft of the transmission apparatus is made coincide with the travel speed of the vehicle and the rotation speeds of the rotary members on both sides of engagement devices are made coincide with each other. However, when the travel speed of the vehicle changes, it is difficult to perform torque reduction at a timing at which the rotation speed of the input shaft of the transmission apparatus is made coincide with the travel speed of the vehicle, so an engagement shock may occur due to mismatch of the timing of torque reduction, formation of a transmission shift stage may take long time because the time period of torque reduction increases, and other problems may occur.

In recent years, hybrid vehicles provided with an internal combustion engine and a rotary electric machine as driving force sources have come into practical use. Some of such hybrid vehicles drive one of the front and rear wheels using the internal combustion engine and drive the other of the front and rear wheels using the rotary electric machine. In such vehicles, engine travel using the internal combustion engine or EV (Electric Vehicle) travel using the rotary electric machine can be performed by driving only one of the front wheels and the rear wheels or four-wheel drive travel can be performed in hybrid travel that drives both of the front wheels and the rear wheels. JP-A-2013-180611 discloses, as one example of such vehicles, a hybrid vehicle in which front-wheel-drive is performed during engine travel, rear-wheel drive is performed during EV travel, and four-wheel drive is performed during hybrid travel (see FIGS. 1 and 2, the nineteenth paragraph, and the like).

As a matter of course, such vehicles make a driving system transition, such as a shift from engine travel to hybrid travel or a shift from EV travel to hybrid travel. During EV travel, the transmission apparatus is put in the neutral state. During a shift from EV travel to hybrid travel, an appropriate transmission shift stage needs to be formed in the transmission apparatus according to the travel speed and torque of the vehicle, the same as above. However, when, for example, the torque becomes insufficient during acceleration in EV travel and a shift to hybrid travel is made, the travel speed of the vehicle also changes as a matter of course. Accordingly, also in such hybrid vehicles, the problem the same as above may occur.

### SUMMARY

To address the problems described in the background art above, it is desirable to provide a technique capable of forming transmission shift stages in the transmission apparatus while reducing an engagement shock of engagement devices even when there is a change in the travel speed of a vehicle traveling in a neutral state in which the transmission apparatus does not form transmission shift stages.

In one preferable exemplary aspect, a vehicle control device addressing the above problems, is a vehicle control device for controlling a vehicle driving device including an internal combustion engine as a driving force source for a wheel and a transmission apparatus, the transmission apparatus including a transmission shift input member drivably coupled to the internal combustion engine, a transmission shift output member drivably coupled to the wheel, and a transmission mechanism having a plurality of engagement devices and selectively forming a plurality of transmission shift stages having different transmission shift ratios depending on engagement states of the plurality of engagement devices, the vehicle control device including a processor that controls the transmission mechanism changing rotation speed of the transmission shift input member at the transmission shift ratios corresponding to the transmission shift stages and transferring the changed rotation speed to the transmission shift output member, when the transmission shift stages are formed in the transmission apparatus from a neutral travel state in which the transmission apparatus does not form the transmission shift stages during rotation of the wheel, based on a temporal change in an output synchronization rotation speed, which is a rotation speed of the transmission shift output member or a member rotating in synchronization with the transmission shift output member, and a temporal change in an input synchronization rotation speed, which is a rotation speed of the transmission shift input member or a member rotating in synchronization with the transmission shift input member, at the time of engagement of the engagement devices for forming the transmission shift stages, torque reduction processing is performed by the processor to reduce an output torque of the internal combustion engine relative to a request torque, which is a torque of the internal combustion engine according to an accelerator opening.

In one preferable aspect, in a transmission apparatus control device for controlling a transmission apparatus which is drivably coupled to an internal combustion engine as a driving force source for a wheel and configures a vehicle driving device in combination with the internal combustion engine, the transmission apparatus includes a transmission shift input member drivably coupled to the internal combustion engine, a transmission shift output member drivably coupled to the wheel, and a transmission mechanism having a plurality of engagement devices and selectively forming a plurality of transmission shift stages having different transmission shift ratios depending on engagement states of the plurality of engagement devices, the transmission apparatus control device includes a process that control the transmission mechanism changing rotation speed of the transmission shift input member at the transmission shift ratios corresponding to the transmission shift stages and transferring the changed rotation speed to the transmission shift output member, when the transmission shift stages are formed in the transmission apparatus from a neutral travel state in which the transmission apparatus does not form the transmission shift stages during rotation of the wheel, based on a temporal change in an output synchronization rotation speed, which is a rotation speed of the transmission shift output member or a member rotating in synchronization with the transmission shift output member, and a temporal change in an input synchronization rotation speed, which is a rotation speed of the transmission shift input member or a member rotating in synchronization with the transmission shift input member, at the time of engagement of the engagement devices for forming the transmission shift stages, a torque reduction request is output to a control device for the internal combustion engine or a control device for the vehicle driving device, the torque reduction request reducing an output torque of the internal combustion engine relative to a request torque, which is a torque of the internal combustion engine according to an accelerator opening.

Note that “the member rotating in synchronization with the transmission shift input member” indicates the member coupled to the transmission shift input member by bypassing engagement elements and the rotation speed (the rotation speed of the member rotating in synchronization with the transmission shift input member) is proportional to the rotation speed of the synchronized rotary member (transmission shift input member). Similarly, “the member rotating in synchronization with the transmission shift output member” indicates the member coupled to the transmission shift output member by bypassing engagement elements and the rotation speed (the rotation speed of the member rotating in synchronization with the transmission shift output member) is proportional to the rotation speed of the synchronized rotary member (transmission shift output member). The input synchronization rotation speed may be the rotation speed of any member rotating in synchronization with the transmission shift input member. Similarly, the output synchronization rotation speed may be the rotation speed of any member rotating in synchronization with the transmission shift output member.

In the above structure, based on a temporal change in the output synchronization rotation speed and a temporal change in the input synchronization rotation speed, at the time of engagement of engagement devices for forming a transmission shift stage, a torque reduction request is output from the transmission apparatus control device to the control device for the internal combustion engine or the control device for the vehicle driving device. Then, torque reduction processing is performed by the control device for the internal combustion engine or the control device (vehicle control device) for the vehicle driving device. At this time, by considering the temporal change in the output synchronization rotation speed and the temporal change in the input synchronization rotation speed, even when the travel speed of the vehicle changes, the control device for the internal combustion engine or the vehicle control device can appropriately perform torque reduction processing at the timing at which the engagement devices are engaged. As a result, it is possible to form a transmission shift stage in the transmission apparatus while reducing an engagement shock of engagement devices even when the travel speed of the vehicle in the neutral travel state changes.

### BRIEF DESCRIPTION OF THE DRAWINGS

FIG. 1 is a block diagram schematically illustrating an example of the structure of a vehicle driving device and a vehicle control device.

FIG. 2 is a skeleton view illustrating the vehicle driving device.

FIG. 3 is an operation table for a transmission apparatus (transmission mechanism).

FIG. 4 is a velocity diagram (collinear figure) illustrating the relationship between the rotation speeds of the rotary elements of the transmission mechanism.

FIG. 5 is a timing chart illustrating an example of timing at which torque reduction processing is performed.

FIG. 6 is a flow chart illustrating an example of torque reduction processing.

### DETAILED DESCRIPTION OF EMBODIMENTS

Embodiments of the disclosure will be described below with reference to the drawings. A vehicle driving device controlled by a vehicle control device according to the disclosure includes at least an internal combustion engine (engine) as a driving force source for wheels and a transmission apparatus. In addition, the vehicle driving device includes at least the transmission apparatus to be controlled by the transmission apparatus control device according to the disclosure and the internal combustion engine (engine) as the driving force source for the wheels. Here, a preferable embodiment of the disclosure will be described using an example in which a hybrid vehicle has a vehicle driving device which further includes a rotary electric machine (motor) as a driving force source for wheels. In other words, preferable embodiments of the disclosure will be described using, as an example, a hybrid vehicle provided with a vehicle driving device including a transmission apparatus, an internal combustion engine, and a rotary electric machine, which is a driving force source for the wheels.

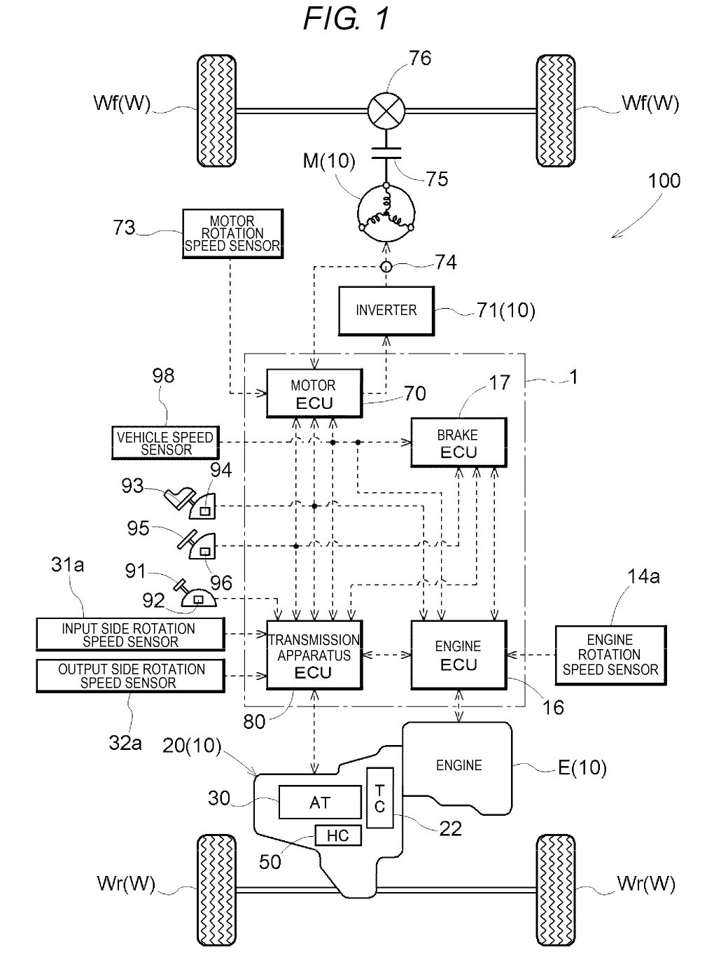

As illustrated in FIG. 1, a vehicle 100 includes a driving device 10 (vehicle driving device) having an engine E (internal combustion engine) as a driving force source for wheels W, a motor M (rotary electric machine) as a driving force source for the wheels W, and a transmission apparatus 20. The engine E is an internal combustion engine that outputs power by explosive combustion of hydrogen or carbon hydride fuel such as gasoline, diesel oil, ethanol, or natural gas. The motor M is an AC rotary electric machine, an inverter 71 performs conversion of electric power between DC electric power supplied from a battery, not illustrated, and AC electric power for the motor M. Note that the motor M can also function as an electric generator. In the embodiment, the engine E is used as the driving force source for rear wheels Wr and the motor M is used as the driving force source for front wheels Wf. That is, the vehicle 100 can perform engine travel (rear-wheel drive travel) using the engine E, EV travel (front-wheel drive travel) using the motor M, and hybrid travel (four-wheel drive travel) using the engine E and the motor M. The driving force of the motor M as the driving force source is transferred to the front wheels Wf via a motor engagement device 75 and a motor differential gear device 76 as power transmission systems.

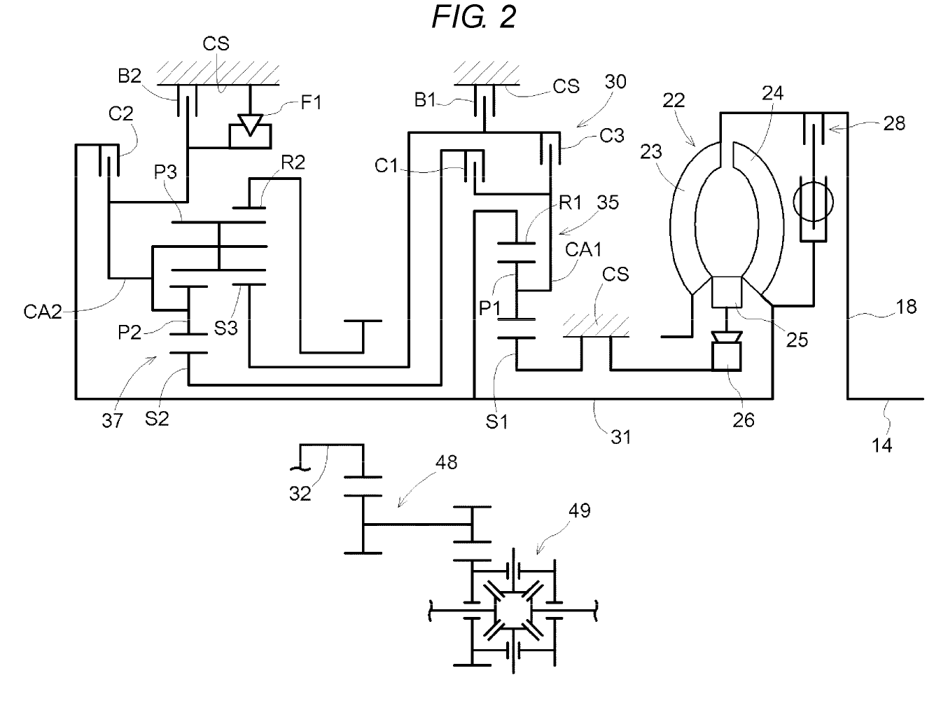

As illustrated in FIGS. 1 and 2, the transmission apparatus 20 includes a fluid transmission device 22 attached to an output shaft 14 of the engine E, a transmission shift input member 31 drivably coupled to the engine E via the fluid transmission device 22, and a transmission shift output member 32 drivably coupled to the wheels W via a gear mechanism 48 and a differential gear 49 (output differential gear device), a transmission mechanism 30, and a hydraulic circuit 50. The hydraulic circuit 50 supplies working oil to the fluid transmission device 22 and the transmission mechanism 30.

Although described in detail later, the transmission mechanism 30 has a plurality of engagement devices (C1, C2, C3, B1, B2, and F1) and selectively forms a plurality of transmission shift stages having different transmission shift ratios depending on the engagement states of the plurality of engagement devices. The transmission apparatus 20 changes the torque and the rotation speed of the transmission shift input member 31 using transmission shift ratios of the transmission shift stages and transfers the changed torque to the transmission shift output member 32. The torque transferred from the transmission apparatus 20 to the transmission shift output member 32 is distributed and transferred to two left and right axles via the differential gear 49 and then transferred to the wheels W (the rear wheels Wr in this example) drivably coupled to the axles. Here, the transmission shift ratio is the ratio of the rotation speed of the transmission shift input member 31 to the rotation speed of the transmission shift output member 32 when the transmission shift stages are formed in the transmission mechanism 30 (for example, “the rotation speed of the transmission shift input member 31/the rotation speed of the transmission shift output member 32”). In other words, the rotation speed of the transmission shift output member 32 equals “the rotation speed of the transmission shift input member 31/the transmission shift ratio”. In addition, the torque transferred from the transmission mechanism 30 to the transmission shift output member 32 equals “the torque transferred from the transmission shift input member 31 to the transmission mechanism 30×the transmission shift ratio”.

Here, “drivably coupling” indicates the state in which two rotary elements are coupled to each other so as to transfer a driving force (torque) and this state includes the state in which the two rotary elements are coupled to each other so as to be integrally rotatable and the state in which the two rotary elements are coupled to each other via one or more transmission members so as to transfer a driving force. Such transmission members include various types of members that transfer rotation by changing or holding the speed, such as, for example, a shaft, gear mechanism, belt, and chain. In addition, such transmission members may include an engagement device selectively transferring rotation and a driving force, such as, for example, a friction clutch (friction engagement device). Accordingly, in the embodiment, the transmission shift input member 31 is drivably coupled to the engine E via the fluid transmission device 22 and the transmission shift output member 32 is drivably coupled to the wheels W via the differential gear 49.

As illustrated in FIG. 2, the fluid transmission device 22 is configured as a fluid type torque converter with a lock-up clutch. The fluid transmission device 22 includes a pump impeller 23, a turbine runner 24, a stator 25, a one-way clutch 26, and a lock-up clutch 28. The pump impeller 23 as an input-side fluid transmission element is connected to the output shaft 14 (crankshaft) of the engine E via a front cover 18. The turbine runner 24 as an output-side fluid transmission element is connected to the transmission shift input member 31 of the transmission mechanism 30 via a turbine hub. The stator 25 is disposed inside the pump impeller 23 and the turbine runner 24 to adjust a flow of working oil from the turbine runner 24 to the pump impeller 23. The one-way clutch 26 restricts the rotation direction of the stator 25 to one direction. The lock-up clutch 28 achieves a lock-up for coupling the pump impeller 23 (front cover 18) to the turbine runner 24 (turbine hub) using engagement.

The fluid transmission device 22 functions as a torque amplifier by the action of the stator 25 when the difference in the rotation speed between the pump impeller 23 and the turbine runner 24 is large or functions as a fluid coupling when the difference in the rotation speed between the pump impeller 23 and the turbine runner 24 is small. When the pump impeller 23 and the turbine runner 24 are locked up by the lock-up clutch 28, power from the engine E mechanically and directly transferred to the transmission shift input member 31. Note that the lock-up clutch 28 is provided with a damper mechanism that absorbs torque fluctuations transferred to the transmission shift input member 31 during a lock-up.

The transmission apparatus 20 (transmission mechanism 30) is configured so that six forward transmission shift stages having different transmission shift ratios and one reverse stage can be selectively formed. As illustrated in FIG. 2, the transmission mechanism 30 in the embodiment includes a first planetary gear mechanism 35 of single pinion type having three rotary elements (S1, R1, and CA1), which will be described later, a Ravigneaux type second planetary gear mechanism 37 having four rotary elements (S2, S3, R2, and CA2), the three clutches (C1, C2, and C3), the two brakes (B1 and B2), and the one-way clutch F1.

The first planetary gear mechanism 35 includes the sun gear S1 as an external gear, the ring gear R1 as an internal gear disposed concentrically with the sun gear S1, a plurality of pinion gears P1 engaged with the sun gear S1 and the ring gear R1, and the carrier CA1 holding the plurality of pinion gears P1 to enable axial rotation and revolution. The sun gear S1 is fixed to a case CS, which is a non-rotary member. The carrier CA1 is drivably coupled to the second sun gear S3 of the second planetary gear mechanism 37 by the third clutch C3 so as to selectively rotate integrally with the second sun gear S3, drivably coupled to the first sun gear S2 of the second planetary gear mechanism 37 by the first clutch C1 so as to selectively rotate integrally with the first sun gear S2, and selectively fixed to the case CS by the first brake B1. The ring gear R1 is drivably coupled to the transmission shift input member 31 so as to rotate integrally with the transmission shift input member 31.

The second planetary gear mechanism 37 includes two sun gears (S2 and S3) of the external gear, a ring gear R2 of the internal gear, a plurality of short pinion gears P2 engaged with the first sun gear S2, a plurality of long pinion gears P3 engaged with the second sun gear S3 and the plurality of short pinion gears P2 and engaged with the ring gear R2, and the carrier CA2 coupling the plurality of short pinion gears P2 and the plurality of long pinion gears P3 to enable axial rotation and revolution. The first sun gear S2 of the second planetary gear mechanism 37 is drivably coupled to the carrier CA1 of the first planetary gear mechanism 35 by the first clutch C1 so as to selectively rotate integrally with the carrier CA1. The second sun gear S3 is drivably coupled to the carrier CA1 of the first planetary gear mechanism 35 by the third clutch C3 so as to selectively rotate integrally with the carrier CA1 and selectively fixed to the case CS by the first brake B1. The carrier CA2 is drivably coupled to the transmission shift input member 31 by the second clutch C2 so as to selectively rotate integrally with the transmission shift input member 31 and selectively fixed to the case CS as a non-rotary member by the second brake B2 or the one-way clutch F1.

The one-way clutch F1 selectively fixes the carrier CA2 to the case CS by allowing the carrier CA2 to rotate relative to the case CS in a first direction (positive rotation direction in this example), which is one direction, and preventing the carrier CA2 from rotating relative to the case CS in a second direction (negative rotation direction in this embodiment), which is the opposite direction. That is, the one-way clutch F1 is a one-direction engagement device that is put in the release state when the relative rotation direction of two members rotating relative to each other is the first direction or put in the engagement state when the relative rotation direction is the second direction, which is opposite to the first direction. The ring gear R2 is drivably coupled to the transmission shift output member 32 so as to rotate integrally with the transmission shift output member 32.

In the embodiment, the plurality of the engagement devices (C1, C2, C3, B1, and B2) except the one-way clutch F1 included in the transmission apparatus 20 (transmission mechanism 30) are friction engagement devices. These engagement devices include, for example, multi-disc clutches and multi-disc brakes that are operated by hydraulic pressure. The friction engagement device is a power transmission mechanism transferring a torque between engagement members using friction between the engagement members. Here, the maximum torque (transmission torque capacity) that can be transferred by friction of a friction engagement device increases proportionally to the engagement pressure of the friction engagement device. The engagement pressure is a pressure at which an input side engagement member (friction disc) and an output side engagement member (friction disc) are pushed against each other. The engagement pressure (engagement state) is controlled by a hydraulic pressure supplied via the hydraulic circuit 50. Note that the motor engagement device 75 is also a friction engagement device.

In the embodiment, the engagement state (the state in which engagement is present) indicates the state in which the transmission torque capacity is generated in the engagement device and this engagement state includes the state (slip engagement state) in which a rotational speed difference (slip) is generated between the input side engagement member and the output side engagement member and the state (direct engagement state) in which the rotational speed difference is not generated between the input side engagement member and the output side engagement member. A non-engagement state (release state) is a state in which the transmission torque capacity is not generated in the engagement device. Note that an indirect engagement state is an engagement state other than the direct engagement state and includes the release state and the slip engagement state.

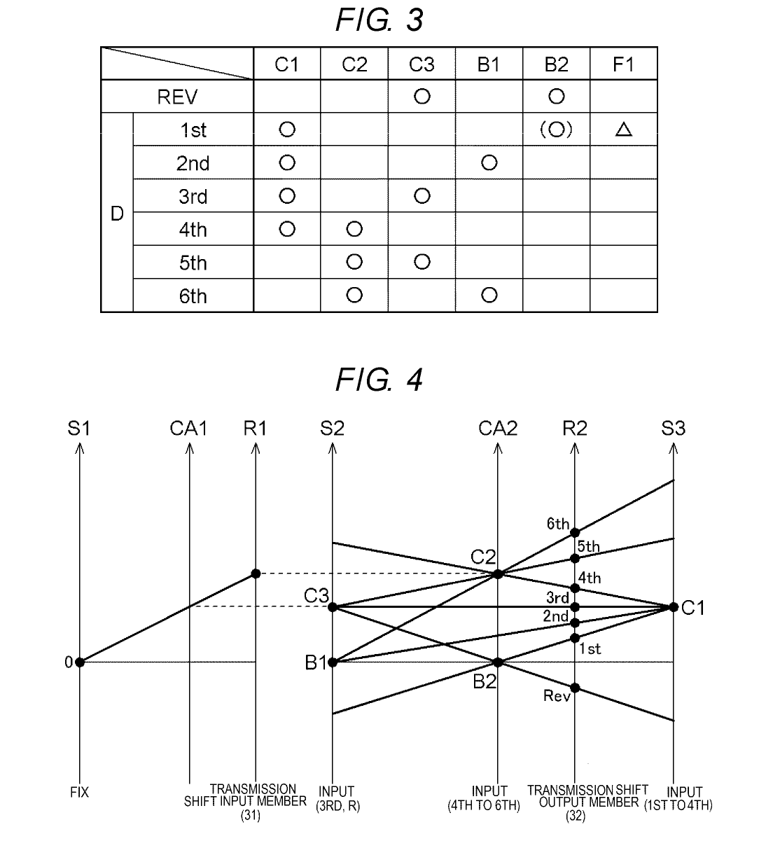

FIG. 3 indicates the relationship between the transmission shift stages of the transmission apparatus 20 (transmission mechanism 30) and the operation states of the clutches (C1, C2, C3, and F1) and the brakes (B1 and B2). In FIG. 3, the mark “∘” indicates that the engagement device is in the engagement state and no mark indicates that the engagement device is in the release state. A mark “∘” indicates that the engagement device is put in the engagement stage during use of engine braking or the like. In addition, a mark “Δ” indicates that the engagement device enters the release stage when rotating in one direction or enters the engagement state when rotating in the other direction.

In the transmission mechanism 30, it is possible to perform switching among the first forward stage (first stage: 1st) to the forward sixth forward stage (sixth stage: 6th), a reverse stage (REV), and neutral (N) by combining the engagement or release (non-engagement) of the clutches (C1, C2, C3, and F1) with the engagement or release (non-engagement) of the brakes (B1 and B2), as illustrated in the operation table in FIG. 3. Note that neutral is the state in which the transmission mechanism 30 does not form any of the transmission shift stages (the first to sixth stages and the reverse stage) (this state may be referred to below as a “neutral state” as appropriate). These forward transmission shift stages include the first stage (1st), the second stage (2nd), the third stage (3rd), the fourth stage (4th), the fifth stage (5th), and the sixth stage (6th) in the descending order of the transmission shift ratio (reduction ratio). FIG. 4 illustrates the relationship of the rotation speeds between the rotary elements included in the transmission mechanism 30.

As illustrated in FIG. 1, the driving device 10 is drive-controlled by a control device 1 (vehicle control device). The control device 1 for controlling the driving device 10 includes an engine ECU (Electronic Control Unit) 16, a brake ECU 17, a motor ECU 70, a transmission apparatus ECU 80, and the like. The ECUs have logic processors such as microprocessors as cores and achieve their functions in cooperation between hardware including peripheral circuits (such as memories) and software such as programs executed by the processors.

The engine ECU 16 controls the engine E based on detection results from a vehicle speed sensor 98, an engine rotation speed sensor 14a, an accelerator pedal position sensor 94, and the like. The vehicle speed sensor 98 detects the travel speed (vehicle speed) of the vehicle 100 based on, for example, the rotation of the wheels W. The engine rotation speed sensor 14a is attached to the output shaft 14 of the engine E and detects the operational state of the engine E, such as the engine rotation speed. The accelerator pedal position sensor 94 detects the amount of operation of an accelerator pedal 93 and the engine ECU 16 performs calculation based on the accelerator opening converted from the amount of operation. The engine ECU 16 controls the engine E by outputting a driving signal to a throttle motor (not illustrated) driving a throttle valve (not illustrated), a control signal to a fuel injection valve (not illustrated), an ignition signal to an ignition plug (not illustrated), and the like.

The brake ECU 17 controls a brake, not illustrated, (for example, an electronic control hydraulic brake) based on the detection results from the vehicle speed sensor 98, a brake pedal position sensor 96, and the like. The brake pedal position sensor 96 detects the amount of operation of a brake pedal 95 and the brake ECU 17 performs calculation based on the amount of braking converted from the amount of operation. The motor ECU 70 controls the motor M via the inverter 71 based on detection results from the vehicle speed sensor 98, the accelerator pedal position sensor 94, the brake pedal position sensor 96, a motor rotation speed sensor 73 such as a resolver, a current sensor 74 detecting electric current flowing through the stator coil of the motor M, and the like.

The transmission apparatus ECU 80 controls the transmission apparatus 20 based on detection results from the vehicle speed sensor 98, the accelerator pedal position sensor 94, the brake pedal position sensor 96, a shift position sensor 92 detecting the operation position of a shift lever 91, an input side rotation speed sensor 31a detecting the rotation of the input side of the transmission apparatus 20 such as the transmission shift input member 31, an output side rotation speed sensor 32a detecting the rotation of the output side of the transmission apparatus 20 such as the transmission shift output member 32, and the like. As illustrated in FIGS. 1 and 2, the transmission apparatus ECU 80 controls the fluid transmission device 22 and the transmission mechanism 30 by controlling the hydraulic circuit 50.

The control device 1 further includes an integrated control function. The integrated control function integrates various types of control performed on the engine E, the motor M, the transmission apparatus 20, the motor engagement device 75, and the like as the entire vehicle. The control device 1 may include an integrated control ECU, not illustrated, in addition to the engine ECU 16, the brake ECU 17, the motor ECU 70, the transmission apparatus ECU 80, and the like or the control device 1 may be included in the integrated control ECU and the engine ECU 16, the brake ECU 17, the motor ECU 70, the transmission apparatus ECU 80, and the like may be included in the integrated control ECU. In any case, the control device 1 has a processor performing integrated control processing and achieves the integrated control function in cooperation between hardware such as the processor and software such as programs executed by the processor.

The control device 1 calculates the torque (vehicle request torque Trq) requested to drive the wheels W according to the accelerator opening, the vehicle speed, the charge amount of battery, and the like and determines the travel modes that use the engine E and the motor M. As described above, the travel modes include the EV travel mode using only the motor M as the driving force source, the engine travel mode using the engine E, and the hybrid travel mode using the motor M and the engine E. For example, when the charge amount of the battery is sufficient during start of the vehicle 100, the EV travel mode is selected. After the start using the EV travel mode, when the accelerator opening is large or the torque becomes insufficient, a shift from the EV travel mode to the hybrid travel mode is made.

During EV travel, the transmission apparatus 20 enters the neutral state in which no transmission shift stages are formed. During a shift from EV travel to hybrid travel, a transmission shift stage appropriate for the travel speed and torque of the vehicle 100 needs to be formed in the transmission apparatus 20 in the neutral state. However, when, for example, the torque becomes insufficient during acceleration in EV travel and a shift to hybrid travel is made, the travel speed of the vehicle 100 also changes as a matter of course. Even in such a case, the transmission shift stage needs to be formed in the transmission apparatus 20 while reducing engagement shocks of the engagement devices (C1, C2, C3, B1, B2, and F1).

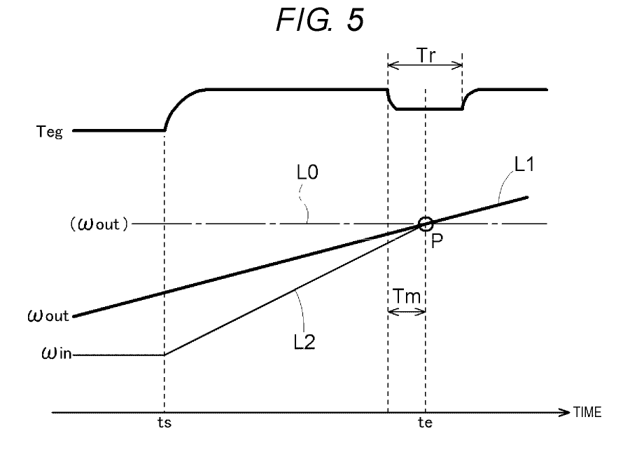

In the embodiment, as illustrated in the timing chart in FIG. 5, at the time of engagement of the engagement device (the one-way clutch F1 in this example) for forming the transmission shift stage, the control device 1 performs torque reduction processing for reducing the output torque (engine output torque Teg) of the engine E with respect to a request torque (engine request torque Trq_e), which is the torque of the engine E according to the accelerator opening. For example, the control device 1 (engine ECU 16) controls the engine E using, as an engine torque instruction Ti_e, the torque obtained by subtracting a predetermined reduction torque Trd from the engine request torque Trq_e.

As illustrated in FIG. 5, in the embodiment, the transmission shift stage is formed in the transmission apparatus 20 from the neutral travel state in the situation in which the rotation speed (output synchronization rotation speed ωout) of the transmission shift output member 32 changes. The neutral travel state is a travel state in which the wheels W are rotating (the vehicle 100 is traveling) and a neutral state in which the transmission apparatus 20 does not form the transmission shift stage. A feature of the disclosure related to the present embodiment resides in that the timing at which torque reduction processing is performed is set so as to match the timing at which such a transmission shift stage is formed, that is, at which the engagement device (the one-way clutch F1 in this example) is engaged. Although described in detail later, the control device 1 performs torque reduction processing based on a temporal change in an output synchronization rotation speed ωout, which is the rotation speed of the transmission shift output member 32 or a member rotating in synchronization with the transmission shift output member 32, and a temporal change in an input synchronization rotation speed ωin, which is the rotation speed of the transmission shift input member 31 or a member rotating in synchronization with the transmission shift input member 31. FIG. 5 illustrates the input synchronization rotation speed win and the output synchronization rotation speed (out as converted values in the case in which the transmission shift ratio of the gear mechanism of the transmission apparatus 20 (transmission mechanism 30) between the output synchronization rotation speed ωout and the input synchronization rotation speed ωin is assumed to be 1.

As illustrated as a dot-dash line “L0” in FIG. 5, when the rotation speed of the transmission shift output member 32 is substantially constant (when the output synchronization rotation speed ωout is substantially constant) even if the wheels W rotate, the control device 1 can perform torque reduction processing simply based on the difference between the input synchronization rotation speed ωin and the output synchronization rotation speed ωout. For example, the control device 1 can make control so as to start torque reduction processing when “ωout-ωin” becomes a predetermined value and end the torque reduction processing when a predetermined time elapses.

However, when the vehicle 100 continuously accelerates, the output synchronization rotation speed ωout increases as illustrated by a solid line “L1” in FIG. 5 even after this condition is met, the rotational speed difference between the output synchronization rotation speed ωout and the input synchronization rotation speed win may not be reduced as expected. Accordingly, since the torque reduction processing has ended when the transmission shift stage is formed in the transmission apparatus 20, an engagement shock may be caused. In addition, when the input synchronization rotation speed win is reduced by the torque reduction processing, the rotational speed difference between the output synchronization rotational speed ωout and the input synchronization rotation speed ωin may be increased. In addition, when the rotation speed of the transmission shift output member 32 is reduced, an engagement shock may be caused since the transmission shift stage is formed before torque reduction processing is started.

In the embodiment, as described above, the control device 1 performs torque reduction processing based on the temporal change in the output synchronization rotation speed ωout, which is the rotation speed of the transmission shift output member 32 or a member rotating in synchronization with the transmission shift output member 32, and the temporal change in the input synchronization rotation speed win, which is the rotation speed of the transmission shift input member 31 or a member rotating in synchronization with the transmission shift input member 31. In the embodiment, the rotation speed of the transmission shift input member 31 detected by the input side rotation speed sensor 31a is assumed to be the input synchronization rotation speed win and the rotation speed of the transmission shift output member 32 detected by the output side rotation speed sensor 32a is assumed to be the output synchronization rotation speed ωout. However, the input synchronization rotation speed win may be the rotation speed of the member (the member coupled by bypassing the engagement element, that is, the member rotating constantly at a rotation speed proportional to the rotation speed of the transmission shift input member 31) rotating in synchronization with the transmission shift input member 31. Similarly, the output synchronization rotation speed ωout may be the rotation speed of the member rotating in synchronization with the transmission shift output member 32.

In addition, preferably, in execution of the torque reduction processing, the control device 1 performs engagement time estimation processing for estimating an engagement time “te” of the engagement device based on the temporal change in the output synchronization rotation speed ωout and the temporal change in the input synchronization rotation speed win. For example, as illustrated in FIG. 5, the control device 1 calculates an intersection point “P” of the line “L1” indicating the output synchronization rotation speed ωout and a line “L2” indicating the input synchronization rotation speed ωin. When the processor included in the control device 1 has sufficient calculation performance, this calculation may be performed by formulating the functions representing “L1” and “L2”.

Preferably, the control device 1 estimates the engagement time based on the change ratio of the output synchronization rotation speed ωout and the change ratio of the input synchronization rotation speed ωin. The control device 1 calculates a change ratio “a” of the output synchronization rotation speed ωout based on the temporal change in the output synchronization rotation speed ωout detected by the output side rotation speed sensor 32a. Since the change ratio of the output synchronization rotation speed ωout is equivalent to the acceleration of the vehicle 100, for example, the control device 1 may use the acceleration “a” of the vehicle 100 detected by an acceleration sensor, not illustrated, as the change ratio “a” of the output synchronization rotation speed ωout. In addition, the control device 1 calculates a change ratio “d” of the input synchronization rotation speed ωin based on the temporal change in the input synchronization rotation speed win detected by the input side rotation speed sensor 31a. At this time, the control device 1 may obtain the change ratio (the acceleration of the engine E) of the input synchronization rotation speed ωin in cooperation with the engine ECU 16.

In one aspect”, a time t that meets “ωout+a·t=ωin+d·t” is obtained and the intersection point “P” is identified. If the time “t” and the intersection point “P” are identified, the engagement time (time) “te” is identified. Torque reduction processing needs to be performed in the engagement time “te”. Accordingly, in torque reduction processing, the output torque (engine output torque Teg) is preferably reduced at a time that is a predetermined margin response time “Tm” before the estimated engagement time “te” in consideration of the responsibility of control.

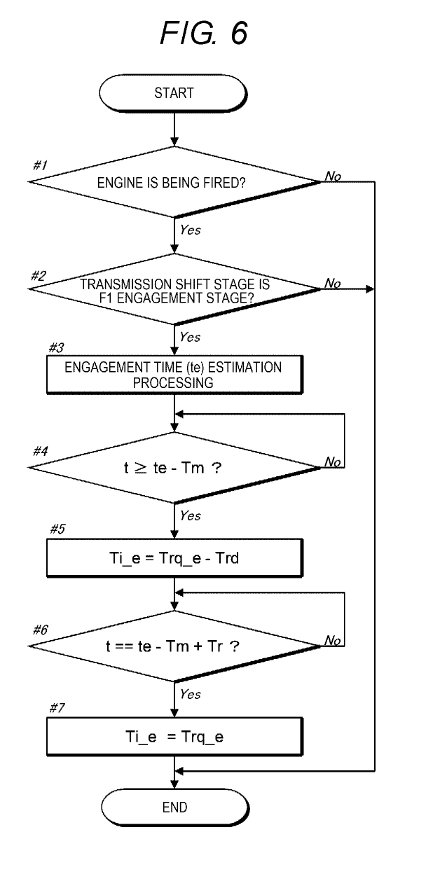

An example of the case in which torque reduction processing is performed will be described below with reference to the flowchart in FIG. 6. This example shows the case in which the engagement device to be engaged is the one-way clutch F1 when the transmission shift stage is formed in the transmission apparatus 20 from the neutral travel state (the state in which the wheels W rotates and the transmission apparatus 20 is in the neutral state). Since, for the one-way clutch F1, the engagement pressure cannot be controlled via the hydraulic circuit 50 unlike the friction engagement device, an engagement shock is preferably reduced by torque reduction processing. This example also shows an aspect in which the engine E is started during EV travel and the one-way clutch F1 is engaged to form the transmission shift stage in the transmission apparatus 20 put in the neutral state immediately after the engine E is started. Note that processes #1 to #7 in the flowchart illustrated in FIG. 6 are torque reduction processing in a broad sense and processes #4 to #7 or process #5 are torque reduction processing in a narrow sense.

Since the engagement device (the one-way clutch F1) is engaged to transfer the power of the engine E via the transmission apparatus 20, first, a determination is made as to whether the engine E is being fired (41). When the engine E is being fired, next, a determination is made as to whether the transmission shift stage to be formed in the transmission apparatus 20 is a one-way clutch engagement stage that uses the one-way clutch F1 (#2). Since the first stage (1st) is a transmission shift stage that uses the one-way clutch F1 as illustrated in FIG. 3 in the embodiment, a determination is made as to whether the transmission shift stage is the first stage. When the engine E is not being fired or the transmission shift stage to be formed in the transmission apparatus 20 is not the first stage, the control device 1 ends the torque reduction processing in a broad sense. That is, the processes #1 and #2 are applied condition determination processes for determining the condition for applying torque reduction processing is met. Note that the transmission shift stage to be formed in the transmission apparatus 20 is determined according to a predetermined transmission shift map based on the vehicle speed and the accelerator opening (or the request torque for the engine E).

As illustrated by dashed lines in FIG. 1, for example, processes #1 and #2 are preferably executed in cooperation between the transmission apparatus ECU 80 and the engine ECU 16. For example, the engine ECU 16 notifies at least the transmission apparatus ECU 80 whether the engine E is being fired using a flag or status signal indicating that the engine E is being fired. Since the transmission shift stage formed in the transmission apparatus 20 is achieved when the transmission apparatus ECU 80 controls the engagement device, the transmission apparatus ECU can determine whether the transmission shift stage is the first stage. That is, the transmission apparatus ECU 80 can determine whether the engine E is being fired (#1) and whether the transmission shift stage is the first stage (#2). When it is determined that the condition is met in processes #1 and #2 (that is, in the applied condition determination processes for determining whether the condition for applying torque reduction processing is met), for example, the transmission apparatus ECU 80 outputs, to the engine ECU 16, a torque reduction request for requesting the execution of torque reduction processing. That is, the transmission apparatus ECU 80 as the transmission apparatus control device outputs a torque reduction request to the engine ECU 16 as the control device for the engine E.

As described above, the control device 1 has the integrated control function that integrates various types of control performed on the engine E, the motor M, the transmission apparatus 20, the motor engagement device 75, and the like as the entire vehicle. As the specific structure, as described above, the control device 1 may include an integrated control ECU, not illustrated, in addition to the engine ECU 16, the brake ECU 17, the motor ECU 70, the transmission apparatus ECU 80, and the like or the control device 1 may be included in the integrated control ECU and the engine ECU 16, the brake ECU 17, the motor ECU 70, the transmission apparatus ECU 80, and the like may be included in the integrated control ECU. Accordingly, the transmission apparatus ECU 80 (transmission apparatus control device) may output a torque reduction request for requesting the execution of torque reduction processing to the control device 1 (vehicle control device).

When the transmission shift stage is the first stage, the engagement time “te” is estimated as described above (#3: engagement time estimation process (engagement time estimation processing)). The engagement time estimation process #3 may be performed by any of the transmission apparatus ECU 80, the engine ECU 16, and the control device 1. When the engagement time estimation process #3 is performed by the transmission apparatus ECU 80, information of the engagement time “te” is preferably output together with the torque reduction request.

The process #4 and subsequent processes are torque reduction processing in a narrow sense and preferably performed centering on the engine ECU 16. As described above, in torque reduction processing, the engine output torque Teg is reduced at a time that is the predetermined margin response time “Tm” before the estimated engagement time “te”. Accordingly, a determination is made as to whether a current time “t” reaches the time at which reduction of the engine output torque Teg is started (#4: torque down start determination process). When the time at which reduction of the engine output torque Teg is started is reached, the control device 1 (the engine ECU 16) sets the torque obtained by subtracting the predetermined reduction torque Trd from the engine request torque Trq_e as the engine torque instruction Ti_e (#5: torque down process). Then, the control device 1 (engine ECU 16) controls the engine E based on the reduced engine torque instruction Ti_c. As a result, the engine output torque Teg is reduced regardless of the engine request torque Trq_e.

In this example, as illustrated in FIG. 5, the engine request torque Trq_e is reduced for a predetermined reduction period Tr. Accordingly, a determination is made as to whether the current time “t” is after the reduction period Tr since the start of the torque down process (#5) (#6: torque down end determination process). When it is determined that the current time “t” is after the reduction period Tr, the control device 1 (engine ECU 16) sets the engine request torque Trq_e as the engine torque instruction Ti_e without subtracting the reduction torque Trd from the engine request torque Trq_e (#7: normal process return process). As a result, the engine E outputs the engine output torque Teg corresponding to the engine request torque Trq_e. That is, the torque reduction processing ends.

As described above, in the structure according to the embodiment, the engagement time of the engagement device (the one-way clutch F1) can be estimated with high accuracy based on the change ratio of the output synchronization rotation speed ωout and the change ratio of the input synchronization rotation speed ωin and torque reduction processing can be performed at the timing of the engagement time. Accordingly, by timely performing torque reduction, an engagement shock can be prevented from occurring even when the vehicle speed changes and the transmission shift stage can be quickly formed by reducing the period for which torque reduction is performed. As described above, according to the disclosure, it is possible to form the transmission shift stage in the transmission apparatus 20 while reducing an engagement shock of engagement devices even when the travel speed of the vehicle 100 in the neutral travel state changes.

### Other Embodiments

Other embodiments of the disclosure will be described below. Incidentally, the configurations of respective embodiments described below are not limited to those respectively applied alone, but as long as no conflict arises, can be applied in combination with the configuration of other embodiments.

(1) The above description uses an example in which the driving device 10 further includes the motor M in addition to the engine E. However, the driving device 10 does not need to include the motor M. For example, when the vehicle 100 travels on a gentle downhill, the driver may perform inertial travel of the vehicle by releasing the accelerator. When the transmission shift stage is formed in the transmission apparatus 20 during inertial travel, a so-called engine braking state in which the wheels W are followed by the engine E and a torque for reducing the speed of the vehicle 100 acts on the wheels W. In such a case, to increase the distance of inertial travel and reduce the fuel consumption of the vehicle 100, the transmission apparatus 20 may be put in the neutral state. To accelerate the vehicle 100 via the driver's accelerator operation from such a neutral state, it is necessary to form an appropriate transmission shift stage according to the travel speed and torque of the vehicle 100 in the transmission apparatus 20 in the neutral state. Accordingly, even in the vehicle 100 without the motor M, torque reduction processing as described above is preferably performed.

(2) The above description uses an example in which the driving device 10 further includes the motor M in addition to the engine E, the engine E is drivably coupled to the rear wheels Wr via the transmission apparatus 20, and the motor M is drivably coupled to the front wheels Wf (the other wheels). However, the engine E may be drivably coupled to the front wheels Wf via the transmission apparatus 20 and the motor M may be drivably coupled to the rear wheels Wr (the other wheels). In addition, the disclosure is not limited to the structure in which the motor M is drivably coupled to wheels (Wf or Wr) different from the wheels (Wr or Wf) to which the engine E is drivably coupled via the transmission apparatus 20 as described above and the engine E and the motor M may be drivably coupled to the same wheels W. However, to drive the wheels W by the driving force of the motor M with the transmission apparatus 20 put in the neutral state, preferably, the motor M is drivably coupled to the rotary member included in the power transmission path between the transmission shift output member 32 and the wheels W. That is, the neutral travel state is a neutral state in which the transmission apparatus 20 does not form any transmission shift stages and is desirably achieved while the torque of the motor M is transferred to any of the wheels W.

(3) The above description uses an example in which the control device 1 performs torque reduction processing at the time of engagement of the one-way clutch F1, which is an engagement device for forming the transmission shift stage. However, the engagement device for forming the transmission shift stage is not limited to the one-way clutch F1 and may be friction engagement devices such as the clutches (C1, C2, and C3) and the brakes (B1 and B2). In the case of friction engagement devices, an engagement shock may be reduced by controlling the engagement pressure. However, torque reduction processing is preferably used to further reduce an engagement shock.

(4) The above description uses an example in which the engagement device (the one-way clutch F1) for forming the transmission shift stage in the transmission apparatus 20 from the neutral travel state is a one-direction engagement device that selectively fixes the carrier CA2 to the case CS by allowing the carrier CA2 to rotate relative to the case CS in a first direction (positive rotation direction in this example) and preventing the carrier CA2 from rotating relative to the case CS in a second direction (negative rotation direction in this embodiment), which is the opposite direction. That is, the above description uses an example in which the one-way clutch F1 functions as a brake. However, when the one-way clutch (F1) is used as an engagement device for forming the transmission shift stage in the transmission apparatus 20 from the neutral travel state, the one-way clutch (F1) may be provided between two rotary members rotating relative to each other so as to function as a clutch.

(5) The above description uses an example in which the rotation speed of the transmission shift input member 31 detected by the input side rotation speed sensor 31a is assumed to be the input synchronization rotation speed win and the rotation speed of the transmission shift output member 32 detected by the output side rotation speed sensor 32a is assumed to be the output synchronization rotation speed wont. However, the input synchronization rotation speed win may be the rotation speed of any member rotating in synchronization with the transmission shift input member 31. In addition, the output synchronization rotation speed ωout may be the rotation speed of any member rotating in synchronization with the transmission shift output member 32. Regardless of the member for which the synchronization rotation speeds (win and wont) are detected, it is preferable to make comparison by conversion to the rotation speed of one reference rotary member of the input synchronization rotation speed win and the output synchronization rotation speed ωout in consideration of the transmission shift ratio of the power transmission path between the detection position of the input synchronization rotation speed win and the detection position of the output synchronization rotation speed wont to determine the engagement time of the engagement device. Note that the member rotating in synchronization is a member coupled by bypassing the engagement element and the rotation speed is proportional to the rotation speed of the synchronized rotary members (the transmission shift input member 31 and the transmission shift output member 32 in this example).

(6) The above description uses an example in which engagement time estimation processing for estimating the engagement time “Te” is performed in torque reduction processing. However, torque reduction processing that does not estimate the engagement time “Te” is not prevented. For example, it is possible to obtain the time at which the rotational speed difference between the output synchronization rotation speed ωout and the input synchronization rotation speed in becomes equal to or less than a predetermined value based on the temporal change in the output synchronization rotation speed ωout and the temporal change in the input synchronization rotation speed win and to reduce the engine output torque Teg for a predetermined period (for example, “the reduction period Tr”) from the obtained time.

[Outline of Embodiments of the Disclosure]

The outline of the vehicle control device (1) and the transmission apparatus control device (80) according to the embodiments of the disclosure as described above will be described in brief.

In one preferable aspect, there is provided a vehicle control device (1) for controlling a vehicle driving device (10) including an internal combustion engine (E) as a driving force source for a wheel (W) and a transmission apparatus (20), in which the transmission apparatus (20) includes a transmission shift input member (31) drivably coupled to the internal combustion engine (E), a transmission shift output member (32) drivably coupled to the wheel (W), and a transmission mechanism (30) having a plurality of engagement devices and selectively forming a plurality of transmission shift stages having different transmission shift ratios depending on engagement states of the plurality of engagement devices, the transmission mechanism (30) changing rotation of the transmission shift input member (31) at the transmission shift ratios corresponding to the transmission shift stages and transferring the changed rotation to the transmission shift output member (32), when the transmission shift stages are formed in the transmission apparatus (20) from a neutral travel state in which the transmission apparatus (20) does not form the transmission shift stages during rotation of the wheel (W), based on a temporal change in an output synchronization rotation speed (ωout), which is a rotation speed of the transmission shift output member (32) or a member rotating in synchronization with the transmission shift output member (32), and a temporal change in an input synchronization rotation speed (ωin), which is a rotation speed of the transmission shift input member (31) or a member rotating in synchronization with the transmission shift input member (31), at the time of engagement of the engagement devices for forming the transmission shift stages, torque reduction processing is performed to reduce an output torque (Teg) of the internal combustion engine (E) relative to a request torque (Trq_e), which is a torque of the internal combustion engine (E) according to an accelerator opening.

As one preferable aspect, in a transmission apparatus control device (80) for controlling a transmission apparatus (20) which is drivably coupled to an internal combustion engine (E) as a driving force source for a wheel (W) and configures a vehicle driving device (10) in combination with the internal combustion engine (E), the transmission apparatus (20) includes a transmission shift input member (31) drivably coupled to the internal combustion engine (E), a transmission shift output member (32) drivably coupled to the wheel (W), and a transmission mechanism (30) having a plurality of engagement devices and selectively forming a plurality of transmission shift stages having different transmission shift ratios depending on engagement states of the plurality of engagement devices, the transmission mechanism (30) changing rotation speed of the transmission shift input member (31) at the transmission shift ratios corresponding to the transmission shift stages and transferring the changed rotation speed to the transmission shift output member (32), when the transmission shift stages are formed in the transmission apparatus (20) from a neutral travel state in which the transmission apparatus (20) does not form the transmission shift stages during rotation of the wheel (W), based on a temporal change in an output synchronization rotation speed (ωout), which is a rotation speed of the transmission shift output member (32) or a member rotating in synchronization with the transmission shift output member (32), and a temporal change in an input synchronization rotation speed (ωin), which is a rotation speed of the transmission shift input member (31) or a member rotating in synchronization with the transmission shift input member (31), at the time of engagement of the engagement devices for forming the transmission shift stages, a torque reduction request is output to a control device (16) for the internal combustion engine (E) or a control device (1) for the vehicle driving device (10), the torque reduction request reducing an output torque (Teg) of the internal combustion engine (E) relative to a request torque (Trq_e), which is a torque of the internal combustion engine (E) according to an accelerator opening.

In the above structure, based on a temporal change in the output synchronization rotation speed (ωout) and a temporal change in the input synchronization rotation speed (ωin), at the time of engagement of engagement devices for forming a transmission shift stage, a torque reduction request is output from the transmission apparatus control device (80) to the control device (16) for the internal combustion engine (E) or the control device (1) for the vehicle driving device (10). Then, torque reduction processing is performed by the control device (16) for the internal combustion engine (E) or the control device (1) (vehicle control device (1)) for the vehicle driving device (10). At this time, by considering the temporal change in the output synchronization rotation speed (ωout) and the temporal change in the input synchronization rotation speed (ωin), even when the travel speed of the vehicle changes, the control device (16) for the internal combustion engine (E) or the vehicle control device (1) can appropriately perform torque reduction processing at the timing at which the engagement devices are engaged. As a result, it is possible to form a transmission shift stage in the transmission apparatus while reducing an engagement shock of engagement devices even when the travel speed of the vehicle in the neutral travel state changes.

In one aspect, in execution of the torque reduction processing, the vehicle control device (1) desirably performs engagement time estimation processing for estimating an engagement time (te) of the engagement device based on the temporal change in the output synchronization rotation speed (ωout) and the temporal change in an input synchronization rotation speed (ωin). Torque reduction processing can be performed at more appropriate timing by estimating the engagement time (te).

When the engagement time of the engagement device is estimated using the change ratios of the output synchronization rotation speed (ωout) and the input synchronization rotation speed (ωin), the accuracy is improved. In addition, in torque reduction processing, the response time from the start of control until the output torque (Teg) of the internal combustion engine (E) is actually reduced is present. Accordingly, it is desirable to start torque reduction processing before the estimated engagement time is reached so that the output torque of the internal combustion engine (E) is reliably reduced at the engagement time of the engagement device. That is, in one aspect, preferably, the vehicle control device (1) estimates the engagement time (te) based on a change ratio (a) of the output synchronization rotation speed (wont) and a change ratio (d) of the input synchronization rotation speed (win) in the engagement time estimation processing and reduces the output torque (Teg) at a time that is a predetermined margin response time (Tm) before the estimated engagement time (te) in the torque reduction processing. In addition, in one aspect, preferably, the vehicle control device (1) estimates a time (te) at which the output synchronization rotation speed (ωout) matches the input synchronization rotation speed (win) based on the output synchronization rotation speed (ωout), the change ratio (a) of the output synchronization rotation speed (ωout), the input synchronization rotation speed (ωin), and the change ratio (d) of the input synchronization rotation speed (ωin) in the engagement time estimation processing and assumes the time (te) to be the engagement time (te) and reduces the output torque (Teg) at a time that is the margin response time (Tm) before the time (te) in the torque reduction processing.

By the way, a friction engagement device, a one-direction engagement device, or the like is known as the engagement device. Although an engagement shock can be reduced by controlling the engagement pressure in a friction engagement device, such control is difficult in a one-direction engagement device. Accordingly, torque reduction is particularly useful when a one-direction engagement device is used as the engagement device. That is, in one aspect, in the vehicle driving device (10) controlled by the vehicle control device (1), the engagement device engaged to form the transmission shift stage in the transmission apparatus (20) from the neutral travel state is preferably the one-direction engagement device (F1) that is put in a release state when a relative rotation direction of two members rotating relative to each other is a first direction or put in an engagement state when the relative rotation direction is changed to a second direction, which is opposite to the first direction. In addition, in one aspect, in the transmission apparatus (20) controlled by the control device (80) for the transmission apparatus (20), the engagement device engaged to form the transmission shift stage in the transmission apparatus (20) from the neutral travel state is preferably the one-direction engagement device (F1) that is put in the release state when a relative rotation direction of two members rotating relative to each other is the first direction or put in the engagement state when the relative rotation direction is changed to the second direction, which is opposite to the first direction.

As described above, torque reduction processing performed by the vehicle control device (1) controls the vehicle driving device (10) including at least the internal combustion engine (E) and the transmission apparatus (20). In recent years, hybrid vehicles provided with the internal combustion engine (E) and the rotary electric machine (M) as driving force sources have come into practical use. In such vehicles, engine travel using the internal combustion engine (E) and the transmission apparatus (20), EV travel using the rotary electric machine (M), and hybrid travel using the internal combustion engine (E) and the rotary electric machine (M) are enabled. Since the transmission apparatus (20) is generally in the neutral state during EV travel, during a transition from EV travel to hybrid travel, it is desirable to form an appropriate transmission shift stage according to the travel speed and torque of the vehicle in the transmission apparatus (20) in the neutral state as in the above case. However, when the torque becomes insufficient during acceleration in EV travel and a shift to hybrid travel is made, the travel speed of the vehicle may also change. Accordingly, also in such a hybrid vehicle, there is a strong need for a technique that forms an appropriate transmission shift stage according to the travel speed and torque of the vehicle in the transmission apparatus (20) in the neutral state while reducing an engagement shock of engagement devices.

That is, in a preferable aspect, the vehicle driving device (10) to be controlled by the vehicle control device (1) further includes the rotary electric machine (M), the rotary electric machine (M) is drivably coupled as described below, and the neutral travel state is achieved as described below. Alternatively, in a preferable aspect, the vehicle driving device (10) includes the transmission apparatus (20) to be controlled by the transmission apparatus control device (80), the internal combustion engine (E), and the rotary electric machine (M), the rotary electric machine (M) is drivably coupled as described below, and the neutral travel state is achieved as described below. Specifically, preferably, the rotary electric machine (M) is drivably coupled to the wheel (Wf) different from the wheel (W(Wr)) to which the internal combustion engine (E) is drivably coupled via the transmission apparatus (20) and the neutral travel state is a neutral state in which the transmission apparatus (20) does not form the transmission shift stages and is achieved while the torque of the rotary electric machine (M) is transferred to the other wheel (Wf). Alternatively, preferably, the rotary electric machine (M) is drivably coupled to the rotary member included in the power transmission path between the transmission shift output member (32) and the wheel (W(Wr)) and the neutral travel state is a neutral state in which the transmission apparatus (20) does not form the transmission shift stages and is achieved while the torque of the rotary electric machine (M) is transferred to the wheel (W).

### INDUSTRIAL APPLICABILITY

The disclosure is applicable to a vehicle control device for controlling a vehicle driving device having an internal combustion engine as a driving force source for wheels and a transmission apparatus and to a transmission apparatus control device for controlling the transmission apparatus which is drivably coupled to the internal combustion engine as the driving force source for the wheels and configures the vehicle driving device in combination with the internal combustion engine.

1-7. (canceled)

8. A vehicle control device for controlling a vehicle driving device including an internal combustion engine as a driving force source for a wheel and a transmission apparatus, wherein the transmission apparatus includes a transmission shift input member drivably coupled to the internal combustion engine, a transmission shift output member drivably coupled to the wheel, and a transmission mechanism having a plurality of engagement devices and selectively forming a plurality of transmission shift stages having different transmission shift ratios depending on engagement states of the plurality of engagement devices, the vehicle control device comprising:
a processor that controls the transmission mechanism changing rotation speed of the transmission shift input member at the transmission shift ratios corresponding to the transmission shift stages and transferring the changed rotation speed to the transmission shift output member,
wherein when the transmission shift stages are formed in the transmission apparatus from a neutral travel state in which the transmission apparatus does not form the transmission shift stages during rotation of the wheel, based on a temporal change in an output synchronization rotation speed, which is a rotation speed of the transmission shift output member or a member rotating in synchronization with the transmission shift output member, and a temporal change in an input synchronization rotation speed, which is a rotation speed of the transmission shift input member or a member rotating in synchronization with the transmission shift input member, at the time of engagement of the engagement devices for forming the transmission shift stages, torque reduction processing is performed by the processor to reduce an output torque of the internal combustion engine relative to a request torque, which is a torque of the internal combustion engine according to an accelerator opening.

9. The vehicle control device according to claim 8, wherein, in execution of the torque reduction processing, engagement time estimation processing for estimating an engagement time of the engagement device is performed by the processor based on the temporal change in the output synchronization rotation speed and the temporal change in the input synchronization rotation speed.

10. The vehicle control device according to claim 9, wherein:
the engagement time estimation processing estimates the engagement time based on a change ratio of the output synchronization rotation speed and a change ratio of the input synchronization rotation speed, and
the torque reduction processing reduces the output torque at a time that is a predetermined margin response time before the estimated engagement time.

11. The vehicle control device according to claim 10, wherein:
the engagement time estimation processing estimates a time at which the output synchronization rotation speed matches the input synchronization rotation speed based on the output synchronization rotation speed, the change ratio of the output synchronization rotation speed, the input synchronization rotation speed, and the change ratio of the input synchronization rotation speed and assumes the time to be the engagement time, and
the torque reduction processing reduces the output torque from the predetermined margin response time before the time.

12. The vehicle control device according to claim 11, wherein the engagement devices engaged to form the transmission shift stages in the transmission apparatus from the neutral travel state include a one-direction engagement device that is put in a release state when a relative rotation direction of two members rotating relative to each other is a first direction or put in an engagement state when the relative rotation direction is changed to a second direction, which is opposite to the first direction.

13. The vehicle control device according to claim 12, wherein:
the vehicle driving device further includes a rotary electric machine, and
the rotary electric machine is drivably coupled to another wheel different from the wheel to which the internal combustion engine is drivably coupled via the transmission apparatus, the neutral travel state is a neutral state in which the transmission apparatus does not form the transmission shift stages and is achieved while a torque of the rotary electric machine is transferred to the other wheel, or
the rotary electric machine is drivably coupled to a rotary member included in a power transmission path between the transmission shift output member and the wheel and the neutral travel state is a neutral state in which the transmission apparatus does not form the transmission shift stages and is achieved while the torque of the rotary electric machine is transferred to the wheel.

14. The vehicle control device according to claim 8, wherein the engagement devices engaged to form the transmission shift stages in the transmission apparatus from the neutral travel state include a one-direction engagement device that is put in a release state when a relative rotation direction of two members rotating relative to each other is a first direction or put in an engagement state when the relative rotation direction is changed to a second direction, which is opposite to the first direction.

15. The vehicle control device according to claim 9, wherein the engagement devices engaged to form the transmission shift stages in the transmission apparatus from the neutral travel state include a one-direction engagement device that is put in a release state when a relative rotation direction of two members rotating relative to each other is a first direction or put in an engagement state when the relative rotation direction is changed to a second direction, which is opposite to the first direction.

16. The vehicle control device according to claim 10, wherein the engagement devices engaged to form the transmission shift stages in the transmission apparatus from the neutral travel state include a one-direction engagement device that is put in a release state when a relative rotation direction of two members rotating relative to each other is a first direction or put in an engagement state when the relative rotation direction is changed to a second direction, which is opposite to the first direction.

17. The vehicle control device according to claim 11, wherein the engagement devices engaged to form the transmission shift stages in the transmission apparatus from the neutral travel state include a one-direction engagement device that is put in a release state when a relative rotation direction of two members rotating relative to each other is a first direction or put in an engagement state when the relative rotation direction is changed to a second direction, which is opposite to the first direction.

18. The vehicle control device according to claim 8, wherein:
the vehicle driving device further includes a rotary electric machine, and
the rotary electric machine is drivably coupled to another wheel different from the wheel to which the internal combustion engine is drivably coupled via the transmission apparatus, the neutral travel state is a neutral state in which the transmission apparatus does not form the transmission shift stages and is achieved while a torque of the rotary electric machine is transferred to the other wheel, or
the rotary electric machine is drivably coupled to a rotary member included in a power transmission path between the transmission shift output member and the wheel and the neutral travel state is a neutral state in which the transmission apparatus does not form the transmission shift stages and is achieved while the torque of the rotary electric machine is transferred to the wheel.

19. The vehicle control device according to claim 9, wherein:
the vehicle driving device further includes a rotary electric machine, and
the rotary electric machine is drivably coupled to another wheel different from the wheel to which the internal combustion engine is drivably coupled via the transmission apparatus, the neutral travel state is a neutral state in which the transmission apparatus does not form the transmission shift stages and is achieved while a torque of the rotary electric machine is transferred to the other wheel, or
the rotary electric machine is drivably coupled to a rotary member included in a power transmission path between the transmission shift output member and the wheel and the neutral travel state is a neutral state in which the transmission apparatus does not form the transmission shift stages and is achieved while the torque of the rotary electric machine is transferred to the wheel.

20. The vehicle control device according to claim 10, wherein:
the vehicle driving device further includes a rotary electric machine, and
the rotary electric machine is drivably coupled to another wheel different from the wheel to which the internal combustion engine is drivably coupled via the transmission apparatus, the neutral travel state is a neutral state in which the transmission apparatus does not form the transmission shift stages and is achieved while a torque of the rotary electric machine is transferred to the other wheel, or
the rotary electric machine is drivably coupled to a rotary member included in a power transmission path between the transmission shift output member and the wheel and the neutral travel state is a neutral state in which the transmission apparatus does not form the transmission shift stages and is achieved while the torque of the rotary electric machine is transferred to the wheel.

21. The vehicle control device according to claim 11, wherein:
the vehicle driving device further includes a rotary electric machine, and
the rotary electric machine is drivably coupled to another wheel different from the wheel to which the internal combustion engine is drivably coupled via the transmission apparatus, the neutral travel state is a neutral state in which the transmission apparatus does not form the transmission shift stages and is achieved while a torque of the rotary electric machine is transferred to the other wheel, or
the rotary electric machine is drivably coupled to a rotary member included in a power transmission path between the transmission shift output member and the wheel and the neutral travel state is a neutral state in which the transmission apparatus does not form the transmission shift stages and is achieved while the torque of the rotary electric machine is transferred to the wheel.

22. A transmission apparatus control device for controlling a transmission apparatus which is drivably coupled to an internal combustion engine as a driving force source for a wheel and configures a vehicle driving device in combination with the internal combustion engine, wherein the transmission apparatus includes a transmission shift input member drivably coupled to the internal combustion engine, a transmission shift output member drivably coupled to the wheel, and a transmission mechanism having a plurality of engagement devices and selectively forming a plurality of transmission shift stages having different transmission shift ratios depending on engagement states of the plurality of engagement devices, the transmission apparatus control device comprising:
a processor that controls the transmission mechanism changing rotation speed of the transmission shift input member at the transmission shift ratios corresponding to the transmission shift stages and transferring the changed rotation speed to the transmission shift output member,
wherein when the transmission shift stages are formed in the transmission apparatus from a neutral travel state in which the transmission apparatus does not form the transmission shift stages during rotation of the wheel, based on a temporal change in an output synchronization rotation speed, which is a rotation speed of the transmission shift output member or a member rotating in synchronization with the transmission shift output member, and a temporal change in an input synchronization rotation speed, which is a rotation speed of the transmission shift input member or a member rotating in synchronization with the transmission shift input member, at the time of engagement of the engagement devices for forming the transmission shift stages, a torque reduction request is output to a control device for the internal combustion engine or a control device for the vehicle driving device, the torque reduction request reducing an output torque of the internal combustion engine relative to a request torque, which is a torque of the internal combustion engine according to an accelerator opening.
